(19) United States
(12) Patent Application Publication
(10) Pub. No.: US 2026/0085941 A1
(43) Pub. Date: Mar. 26, 2026

(54) TRAVEL ROUTE PROPOSING SYSTEM, TRAVEL ROUTE PROPOSING METHOD, AND STORAGE MEDIUM

(71) Applicant: HONDA MOTOR CO., LTD., Tokyo (JP)

(72) Inventor: Ryo Yukimasa, Tokyo (JP)

(21) Appl. No.: 19/323,672

(22) Filed: Sep. 9, 2025

(30) Foreign Application Priority Data
Sep. 20, 2024 (JP) 2024-164302

(51) Int. Cl. G01C 21/36

(52) U.S. Cl. CPC G01C 21/3617; G01C 21/3682

(57) ABSTRACT

A travel route proposing system that classifies a plurality of users into a plurality of classes on the basis of activity history information about the users, obtains map information about a target area including a destination set by a target user and a current position of the target user, extracts a candidate spot through which the target user is able to travel from the current position of the target user to the destination on the basis of the map information and determine whether or not to use the candidate spot as a proposed spot to be proposed to the target user to drop in on the basis of the activity history information about the users belonging to a target class that is the class to which the target user belongs, and outputs information about the proposed spot.

### INCORPORATION BY REFERENCE

The present application claims priority under 35 U.S.C. § 119 to Japanese Patent Application No. 2024-164302 filed on Sep. 20, 2024. The content of the application is incorporated herein by reference in its entirety.

### BACKGROUND OF THE INVENTION

### Field of the Invention

The present invention relates to a travel route proposing system, a travel route proposing method, and a storage medium that each propose a travel route to a destination.

### Description of the Related Art

In recent years, more active efforts have been made to provide access to a sustainable transportation system that takes into consideration even people in vulnerable positions among traffic participants. To achieve this, efforts have been invested in research and development for still further improving traffic safety and convenience by researching and developing navigation technology.

For example, Japanese Patent Laid-Open No. 2011-60059 discloses an activity plan providing method that provides a user with activity plan information on the basis of estimated stay time estimated from activity information about the user in a place that the user plans to visit and preference information about the user. In addition, Japanese Patent Laid-Open No. 2019-124605 discloses an information processing apparatus that provides the next destination to a guide target user on the basis of stay time of the guide target user at a destination.

It is, however, conceivable that the navigation technology proposes a stopover spot which meets the needs of a user to make comfortable the travel to a destination set by the user. The technologies described in Japanese Patent Laid-Open No. 2011-60059 and No. 2019-124605 above, however, propose destinations to users and it is not thus possible to propose stopover spots that meet the needs of the users depending on the destinations set by the users. Accordingly, a problem of this application is to propose a stopover spot that meets the needs of a user when the user sets a destination.

To solve the problem, an object of this application is to provide a travel route proposing system and a travel route proposing method each capable of proposing a stopover spot that is highly likely to match the needs of a user when the user sets a destination. This eventually contributes to the development of a sustainable transportation system.

### SUMMARY OF THE INVENTION

A first aspect to achieve the object includes a travel route proposing system including an activity history information obtaining section, a user clustering section, a destination recognizing section, a user position recognizing section, a map information obtaining section, a proposed spot determining section, and a proposed spot information output section. The activity history information obtaining section is configured to obtain activity history information for a plurality of users. The activity history information indicates an activity history of each of the users. The user clustering section is configured to classify a plurality of the users into a plurality of classes on the basis of the activity history information. The destination recognizing section is configured to recognize a destination set by a target user who is any of a plurality of the users. The user position recognizing section is configured to recognize a current position of the target user. The map information obtaining section is configured to obtain map information about a target area including the destination and the current position of the target user. The proposed spot determining section is configured to extract, on the basis of the map information, a candidate spot through which the target user is able to travel from the current position of the target user to the destination, and determine whether or not to use the candidate spot as a proposed spot to be proposed to the target user to drop in on the basis of the activity history information about the users belonging to a target class that is the class to which the target user belongs. The proposed spot information output section is configured to output information about the proposed spot.

In the travel route proposing system may have a configuration in which the travel route proposing system includes a drop-in selection receiving section, and a proposed route setting section. The drop-in selection receiving section is configured to receive selection of necessity or unnecessity to drop in at the proposed spot by the target user for an output of the information about the proposed spot by the proposed spot information output section. The proposed route setting section is configured to, when the selection of the necessity to drop in at the proposed spot is received by the drop-in selection receiving section, set a proposed route from the current position of the target user to the destination through the proposed spot on the basis of the map information.

The travel route proposing system may have a configuration in which the activity history information includes proposal result data in which the information about the proposed spot and a result of reception of the selection of the necessity or unnecessity to drop in at the proposed spot by the drop-in selection receiving section are associated. The travel route proposing system includes a route proposing model generating section configured to generate a route proposing model for each of a plurality of the classes. The route proposing model carries out machine learning for each of a plurality of the classes to output a determination as to whether or not to use the candidate spot as the proposed spot in response to an input of the information about the candidate spot. The machine learning uses training data based on the proposal result data for each of the users belonging to the classes. The proposed spot determining section determines whether or not to use the candidate spot as the proposed spot by using the route proposing model corresponding to the target class.

The travel route proposing system may have a configuration in which the activity history information includes the proposal result data in which the information about the proposed spot and a travel status at time of a proposal, and the result of the reception of the selection of the necessity or unnecessity to drop in at the proposed spot by the drop-in selection receiving section are associated. The travel status is a travel status of the user at time when the proposed spot information output section outputs the information about the proposed spot. The route proposing model generating section generates the route proposing model that outputs the determination as to whether or not to use the candidate spot as the proposed spot in response to inputs of the information about the candidate spot and the travel status of the user.

The travel route proposing system may have a configuration in which the route proposing model generating section assigns a weight to the candidate spot for which the selection of the necessity to drop in is received by the drop-in selection receiving section such that the candidate spot is extracted as the proposed spot more preferentially than the candidate spot for which the selection of the unnecessity to drop in is received by the drop-in selection receiving section, and generates the route proposing model by the machine learning.

The travel route proposing system may have a configuration in which, when new proposal result data is added to the activity history information, the route proposing model generating section uses the added proposal result data to relearn the route proposing model corresponding to the class to which the user targeted by the added proposal result data belongs.

The travel route proposing system may have a configuration in which the travel route proposing system includes a desired arrival time recognizing section configured to recognize a desired arrival time that is an arrival time at the destination desired by the target user. The proposed spot determining section extracts, as the candidate spot, a spot that allows the target user to arrive at the destination by the desired arrival time after dropping in.

A second aspect to achieve the object includes a travel route proposing method that is executed by a computer. The travel route proposing method includes an activity history information obtaining step, a user clustering step, a destination recognizing step, a user position recognizing step, a map information obtaining step, a proposed spot determining step, and a proposed spot information output step. In the activity history information obtaining step, activity history information is obtained for a plurality of users. The activity history information indicates an activity history of each of the users. In the user clustering step, a plurality of the users is classified into a plurality of classes on the basis of the activity history information. In the destination recognizing step, a destination set by a target user who is any of a plurality of the users is recognized. In the user position recognizing step, a current position of the target user is recognized. In the map information obtaining step, map information about a target area including the destination and the current position of the target user is obtained. In the proposed spot determining step, on the basis of the map information, a candidate spot through which the target user is able to travel from the current position of the target user to the destination is extracted, and whether or not to use the candidate spot as a proposed spot to be proposed to the target user to drop in is determined on the basis of the activity history information about the users belonging to a target class that is the class to which the target user belongs. In the proposed spot information output step, information about the proposed spot is output.

A third aspect to achieve the object includes a non-transitory computer-readable storage medium storing a program that causes a computer to function as an activity history information obtaining section, a user clustering section, a destination recognizing section, a user position recognizing section, a map information obtaining section, a proposed spot determining section, and a proposed spot information output section. The activity history information obtaining section is configured to obtain activity history information for a plurality of users. The activity history information indicates an activity history of each of the users. The user clustering section is configured to classify a plurality of the users into a plurality of classes on the basis of the activity history information. The destination recognizing section is configured to recognize a destination set by a target user who is any of a plurality of the users. The user position recognizing section is configured to recognize a current position of the target user. The map information obtaining section is configured to obtain map information about a target area including the destination and the current position of the target user. The proposed spot determining section is configured to extract, on the basis of the map information, a candidate spot through which the target user is able to travel from the current position of the target user to the destination, and determine whether or not to use the candidate spot as a proposed spot to be proposed to the target user to drop in on the basis of the activity history information about the users belonging to a target class that is the class to which the target user belongs. The proposed spot information output section is configured to output information about the proposed spot.

### Advantageous Effects of Invention

The travel route proposing system, the travel route proposing method, and the storage medium each make it possible to propose a stopover spot that is highly likely to match the needs of a user when the user sets a destination.

### BRIEF DESCRIPTION OF THE DRAWINGS

FIG. 1 is a configuration diagram of a travel route proposing system according to the present embodiment;

FIG. 2 is an explanatory diagram of data stored in a storage device;

FIG. 3 is an explanatory diagram of clustering of a plurality of users;

FIG. 4 is an explanatory diagram of a process of generating a route proposing model;

FIG. 5 is a first flowchart of a process of proposing to drop in at a proposed spot;

FIG. 6 is a second flowchart of the process of proposing to drop in at the proposed spot; and

FIG. 7 is an explanatory diagram of a series of processes from determination of the proposed spot to storage of a result of selection of dropping in at the proposed spot.

### DETAILED DESCRIPTION OF THE INVENTION

### 1. Configuration of Travel Route Proposing System

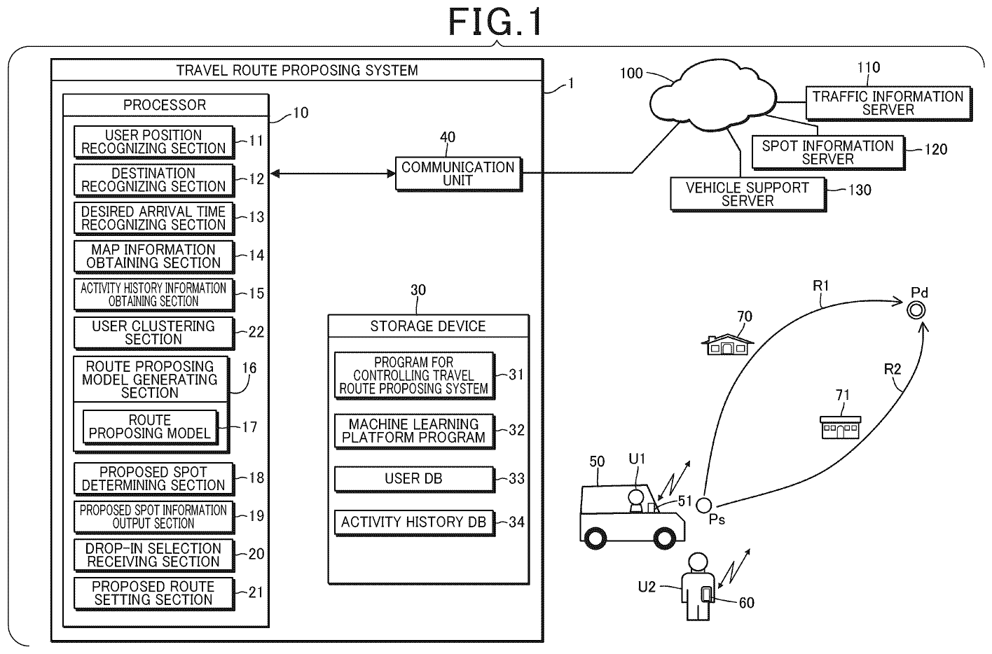

The configuration of a travel route proposing system 1 according to the present embodiment will be described with reference to FIG. 1. The travel route proposing system 1 is a computer system connected to a communication network 100. The travel route proposing system 1 communicates with a communication terminal used by a user of the travel route proposing system 1 through the communication network 100 to provide the user with information about a spot at which it is possible to drop in while the user is traveling to a destination.

FIG. 1 exemplifies a user U1 who travels in a vehicle 50 and a user U2 who travels by foot as users of the travel route proposing system 1. In FIG. 1, Ps represents the current position of each of the users U1 and U2 and Pd represents a destination of each of the users U1 and U2. The travel route proposing system 1 provides the user U1 with information about a spot at which it is possible to drop in through communication with a communication terminal 51 (such as a navigation apparatus, a DA (Display Audio), a smartphone, a tablet terminal, or a mobile phone) included in the vehicle 50 or brought to the vehicle 50 by the user U1. In addition, the travel route proposing system 1 provides the user U2 with information about a spot at which it is possible to drop in through communication with a communication terminal 60 (such as a smartphone, a tablet terminal, or a mobile phone) carried by the user U2.

Furthermore, the travel route proposing system 1 communicates with various servers such as a traffic information server 110, a spot information server 120, and a vehicle support server 130 through the communication network 100. The traffic information server 110 provides traffic information such as a map and a road regulation. The spot information server 120 provides information about a spot (such as a restaurant, a truck stop, a drive-in, or a sightseeing spot) at which it is possible to drop in. The vehicle support server 130 receives information about travel statuses (such as a travel location, travel time, and travel speed) from a service target vehicle such as the vehicle 50 and stores the received information.

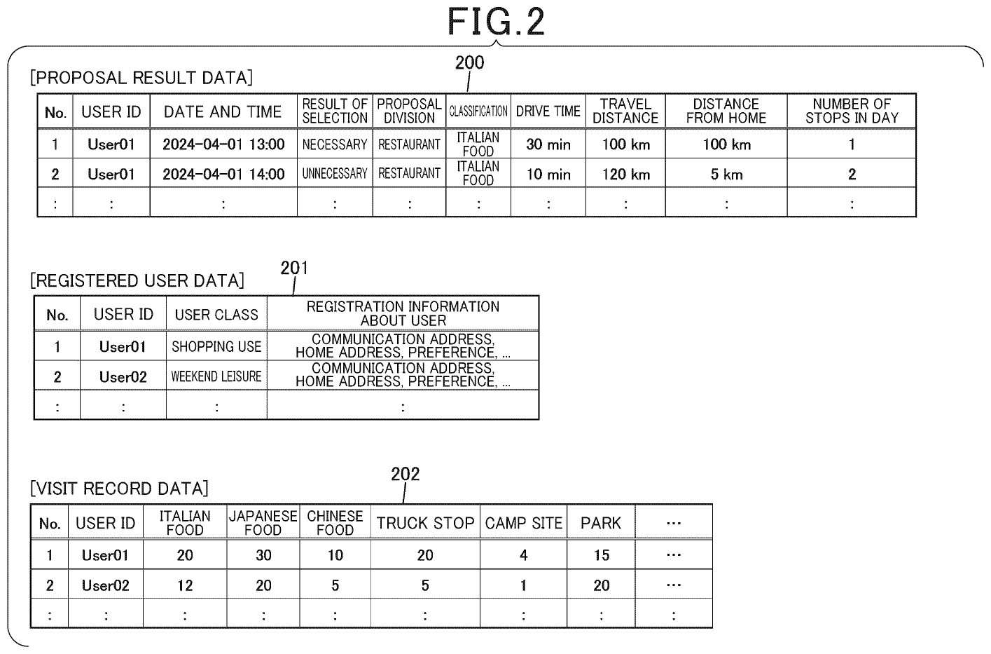

The travel route proposing system 1 includes a processor 10 (corresponding to a computer according to the present disclosure), a storage device 30, a communication unit 40 (a transmitter and a receiver), and the like. The storage device 30 is a memory and stores a program 31 (corresponding to a program according to the present disclosure) for controlling the travel route proposing system 1, a machine learning platform program 32, a user DB (database) 33, and an activity history DB 34. As illustrated in FIG. 2, the user DB 33 records registered user data 201 in which user IDs (User01, User02, . . . ) individually issued for a plurality of users registered in the travel route proposing system 1, and classes (illustrated as user classes in FIG. 2) to which the users belong and pieces of registration information (such as communication addresses, home addresses, and preferences) input by the respective users at the time of registration are associated. A class to which a user belongs is determined through a clustering process described below.

The activity history DB 34 records proposal result data 200 and visit record data 202 illustrated in FIG. 2 for each of the users. The proposal result data 200 and the visit record data 202 each correspond to activity history information according to the present disclosure. The proposal result data 200 includes, for a proposal made to a user to drop in at a proposed spot, the date and time of the proposal, a result (necessary or unnecessary) of the selection of the necessity or unnecessity to drop in at the proposed spot by the user, information (proposal division and classification) about the proposed spot, and travel statuses at the time of the proposal, that is, travel statuses (drive time, travel distance, distance from home, and the number of stops in the day) of the user at the time of the proposal. The visit record data 202 records the number of visits by dividing spots a user has ever visited on the basis of genres. The visit record data 202 is used for the clustering of users described below, the estimation of the preferences of users in spots, and the like.

The processor 10 reads and executes the program 31 for controlling the travel route proposing system 1 to function as a user position recognizing section 11, a destination recognizing section 12, a desired arrival time recognizing section 13, a map information obtaining section 14, an activity history information obtaining section 15, a user clustering section 22, a route proposing model generating section 16, a proposed spot determining section 18, a proposed spot information output section 19, a drop-in selection receiving section 20, and a proposed route setting section 21.

Here, the process executed by the user position recognizing section 11 corresponds to a user position recognizing step in the travel route proposing method according to the present disclosure and the process executed by the destination recognizing section 12 corresponds to a destination recognizing step in the travel route proposing method according to the present disclosure. The process executed by the map information obtaining section 14 corresponds to a map information obtaining step in the travel route proposing method according to the present disclosure and the process executed by the activity history information obtaining section 15 corresponds to an activity history information obtaining step in the travel route proposing method according to the present disclosure. The process executed by the proposed spot determining section 18 corresponds to a proposed spot determining step in the travel route proposing method according to the present disclosure and the process executed by the proposed spot information output section 19 corresponds to a proposed spot information output step in the travel route proposing method according to the present disclosure. The process executed by the user clustering section 22 corresponds to a user clustering step in the travel route proposing method according to the present disclosure.

The following describes a case where a proposal is made to the user U1 who drives the vehicle 50 and travels from the current position Ps to the destination Pd to drop in at a spot present in the middle of the travel route. The same applies to a proposal made to another user such as the user U2 to drop in at a spot.

The user position recognizing section 11 communicates with the communication terminal 51 to obtain information about the detection of the current position (the current position of the vehicle 50) of the user U1 detected by a position sensor such as a GNSS (Global Navigation Satellite System) sensor included in the communication terminal 51 and recognize the current position of the user U1.

The destination recognizing section 12 communicates with the communication terminal 51 to recognize the destination Pd set by the user U1 operating the communication terminal 51. The desired arrival time recognizing section 13 communicates with the communication terminal 51 to recognize desired arrival time at the destination Pd set by the user U1 operating the communication terminal 51.

The map information obtaining section 14 accesses the traffic information server 110 to obtain map information about the target area including the current position Ps of the user U1 and the destination Pd from the traffic information server 110. The activity history information obtaining section 15 communicates with the communication terminal 51 or accesses the vehicle support server 130 to obtain travel history information about the vehicle 50, and recognizes a result of the reception of the selection of the necessity or unnecessity to drop in at a proposed spot by the drop-in selection receiving section 20 described below to generate the proposal result data 200 and records the generated proposal result data 200 in the activity history DB 34.

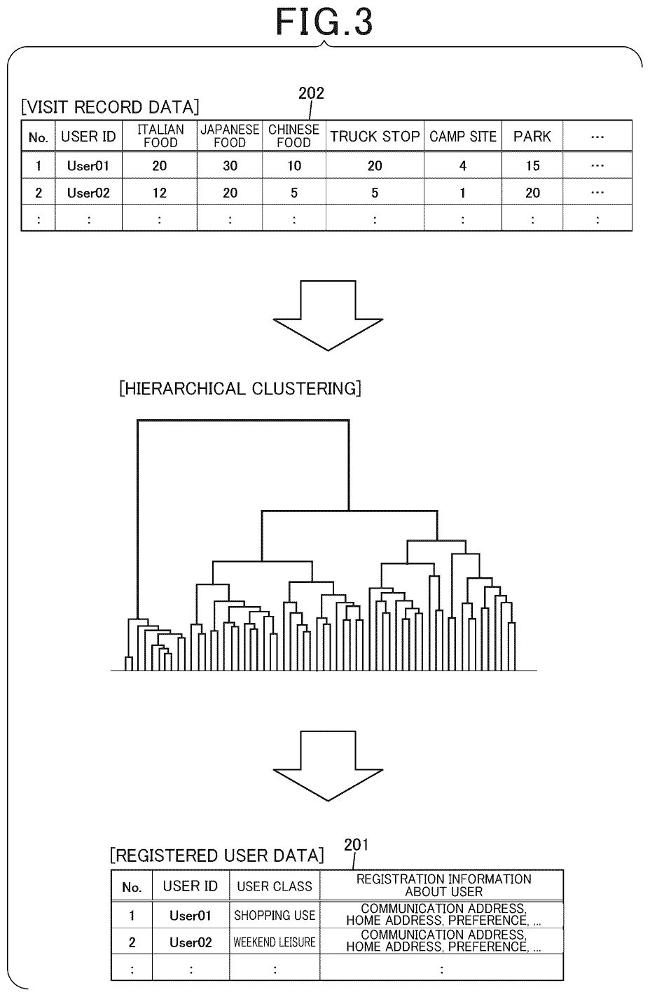

As illustrated in FIG. 3, the user clustering section 22 carries out hierarchical clustering on a plurality of users by using the number of visits to spots in each of categories (Italian food, Japanese food, Chinese food, . . . ). The number of visits is counted for each of the users and recorded in the visit record data 202. The user clustering section 22 then calculates a silhouette score and automatically sets the number of clusters at which the silhouette score reaches the maximum. The classes (FIG. 3 exemplifies shopping use and weekend leisure) to which the respective users classified by the user clustering section 22 belong are recorded in the registered user data 201.

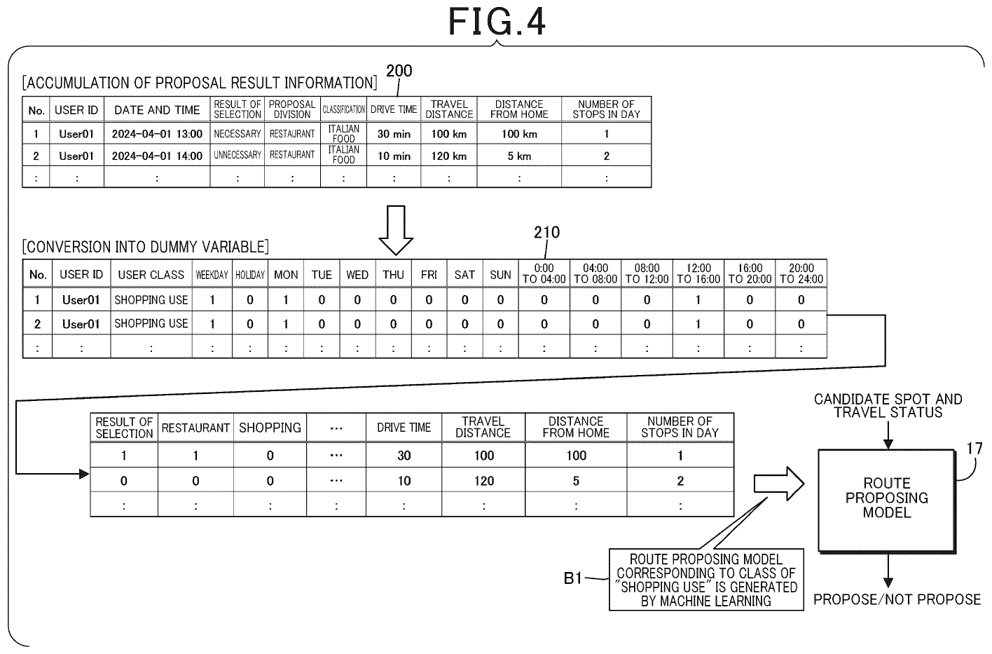

As illustrated in FIG. 4, the route proposing model generating section 16 classifies the proposal result data 200 accumulated for a plurality of users for each of the classes with reference to the classes of the respective users recorded in the registered user data 201 (see FIG. 2). The route proposing model generating section 16 then individually generates route proposing models 17 corresponding to the respective classes by using the proposal result data 200 classified for each of the classes.

FIG. 4 exemplifies a case where a route proposing model corresponding to the class of “shopping use” is generated. The route proposing model generating section 16 subjects the proposal result data 200 of users belonging to the class of “shopping use” to a dummy variable conversion process of subdividing the proposed date and time (a weekday, a holiday, the day of the week, and a time slot) and subdividing (on the basis of a genre, an object, and the like) an attribute of a proposed spot, and generates training data 210 in which information about a proposed spot and a travel status are used as examples and a result of the selection is used as a correct answer.

The route proposing model generating section 16 then executes the machine learning platform program 32 and carries out machine learning by using the training data 210 to generate the route proposing model 17 that corresponds to the class of “shopping use” and outputs a determination as to whether or not to propose a candidate spot as a proposed spot in response to the inputs of pieces of information about the candidate spot and the travel statuses of a user as illustrated with a speech balloon B1. The route proposing model generating section 16 performs similar processes on the other classes to individually generate the route proposing models 17 corresponding to the respective classes.

Here, when the route proposing model generating section 16 generates the route proposing model 17 by machine learning, the route proposing model generating section 16 may assign a weight to a candidate spot for which the selection of the necessity to drop in is received by the drop-in selection receiving section 20 such that the candidate spot is extracted as a proposed spot more preferentially than a candidate spot for which the selection of the unnecessity to drop in is received by the drop-in selection receiving section 20.

The proposed spot determining section 18 accesses the spot information server 120 and obtains information about a spot present near the user U1 to extract a candidate spot at which it is possible for the user U1 to drop in on the way to the destination Pd. In this case, the proposed spot determining section 18 extracts a candidate spot under the condition that it is possible to arrive at the destination Pd by the desired arrival time recognized by the desired arrival time recognizing section 13.

The proposed spot determining section 18 then inputs the information about the candidate spot and the travel statuses of the user U1 to the route proposing model 17 and determines whether or not to use the candidate spot as a proposed spot to be proposed to the user U1 to drop in depending on the output of a determination by the route proposing model 17. The proposed spot information output section 19 transmits the information about the proposed spot to the communication terminal 51 and proposes to drop in at the proposed spot. The drop-in selection receiving section 20 receives result data of the selection of the necessity or unnecessity to drop in at the proposed spot that is transmitted from the communication terminal 51, and receives the selection of dropping in at the proposed spot.

When the drop-in selection receiving section 20 receives the selection of the necessity to drop in at the proposed spot, the proposed route setting section 21 sets a proposed route from the current position of the user U1 (the current position of the vehicle 50) to the destination Pd through the proposed spot and transmits information about the proposed route to the communication terminal 51. The communication terminal 51 that receives the information about the proposed route displays the information about the proposed route on a display and executes the route guide of the proposed route in response to an instruction of the user U1.

### 2. Process of Proposing to Drop in at Proposed Spot

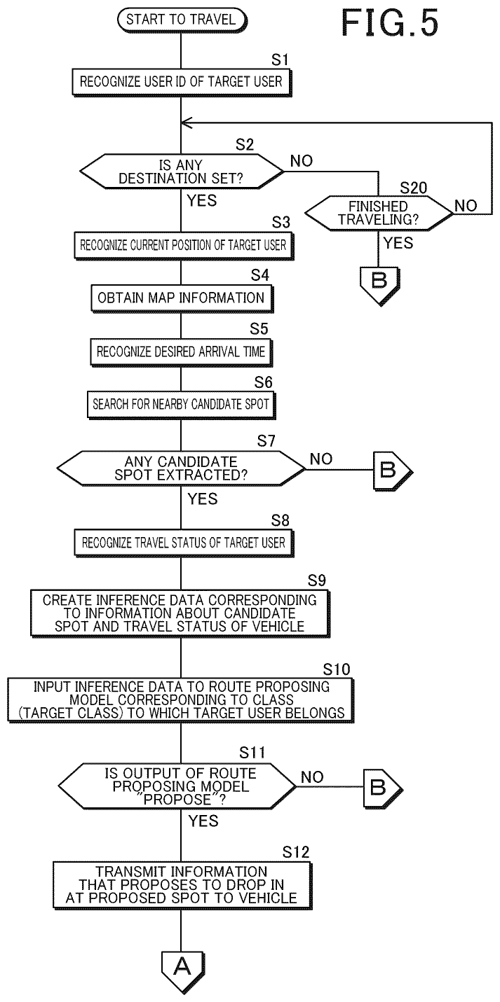

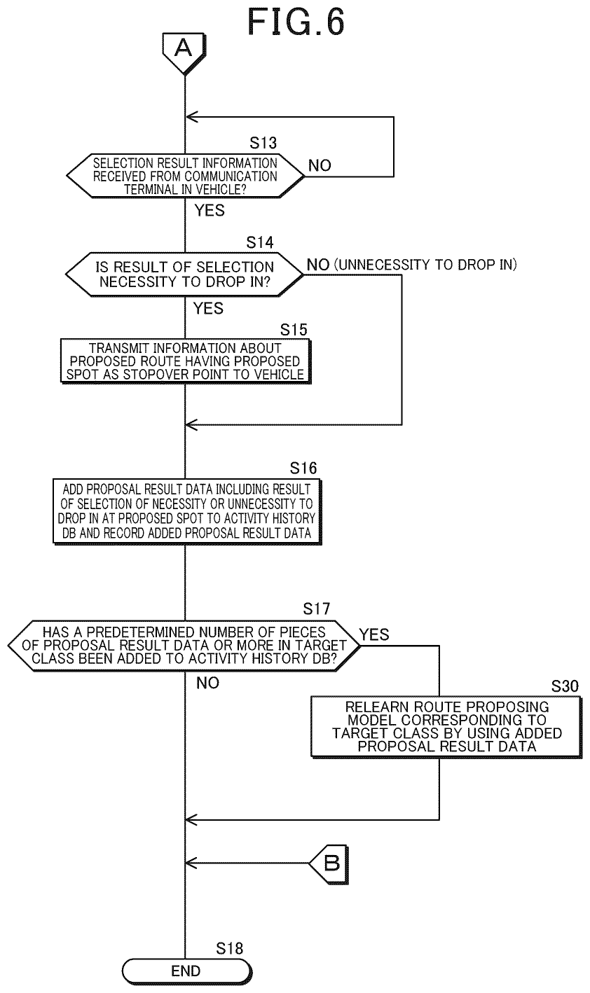

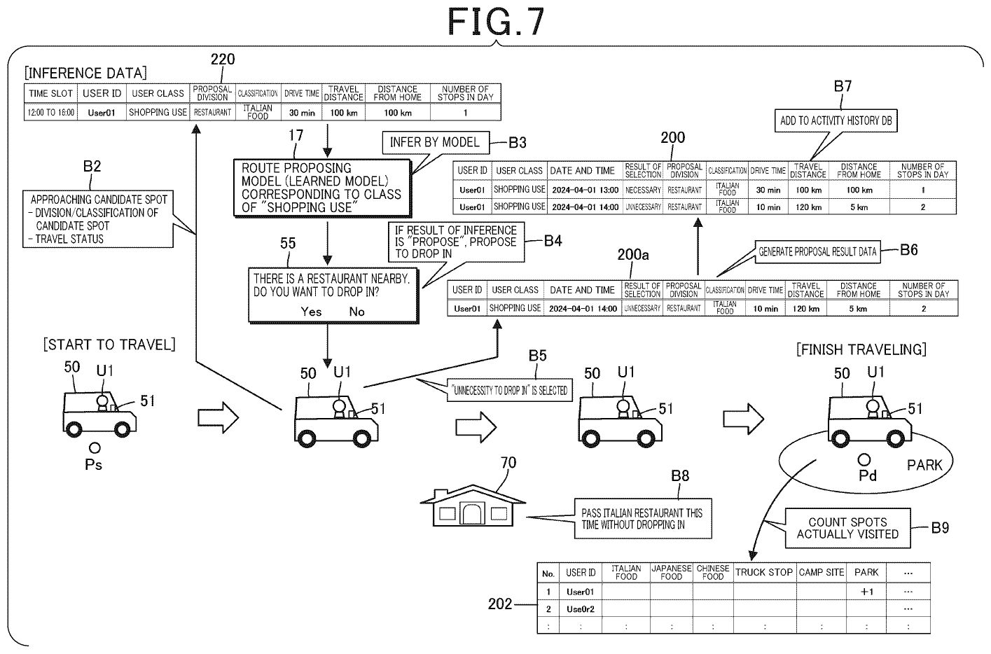

A procedure of a process of proposing to the user U1 to drop in at a proposed spot that is executed by the travel route proposing system 1 in the situation illustrated in FIG. 1 will be described in accordance with the flowcharts illustrated in FIGS. 5 and 6 with reference to the overview of the series of processes illustrated in FIG. 7. In this case, the user U1 corresponds to a target user according to the present disclosure.

When recognizing that the user U1 starts to travel in the vehicle 50 through communication with the communication terminal 51, the travel route proposing system 1 executes a process of proposing to drop in at a proposed spot in accordance with the flowcharts of FIGS. 5 and 6. In step S1 in FIG. 5, the travel route proposing system 1 recognizes the user ID of the user U1 and identifies the user U1 through communication with the communication terminal 51.

In subsequent step S2, the destination recognizing section 12 determines whether or not a destination of the user U1 is set through communication with the communication terminal 51. When a destination is set, the destination recognizing section 12 advances the process to step S3. When no destination is set, the destination recognizing section 12 advances the process to step S20. In step S20, the destination recognizing section 12 determines whether or not the user U1 has finished traveling in the vehicle 50 through communication with the communication terminal 51. The destination recognizing section 12 then advances the process to step S18 in FIG. 6 when the user U1 has finished traveling. When the user U1 keeps on traveling, the destination recognizing section 12 advances the process to step S2.

In step S3, the user position recognizing section 11 recognizes the current position of the user U1 (the current position of the vehicle 50) through communication with the communication terminal 51. In subsequent step S4, the map information obtaining section 14 obtains map information about the target area including the current position Ps of the user U1 and the destination Pd and traffic information about the roads from the traffic information server 110. In next step S5, the desired arrival time recognizing section 13 recognizes desired arrival time at the destination Pd set by the user U1 through communication with the communication terminal 51.

In next step S6, the proposed spot determining section 18 searches for a candidate spot with reference to the map information and the traffic information under the condition that it is possible to arrive at the destination Pd by the desired arrival time. The candidate spot is a spot at which it is possible for the user U1 to drop in when traveling from the current position Ps to the destination Pd. Here, the proposed spot determining section 18 anticipates typical stay time at the spot depending on the genre (such as a restaurant, a truck stop, a drive-in, or a convenience store) of the spot and searches for a candidate spot through which it is possible to arrive at the destination Pd by the desired arrival time when the user U1 drops in at the candidate spot.

In subsequent step S7, the proposed spot determining section 18 advances the process to S7 when a candidate spot is extracted. When no candidate spot is extracted, the proposed spot determining section 18 advances the process to step S18 in FIG. 6 and brings the drop-in proposing process performed this time to an end. In step S8, the proposed spot determining section 18 recognizes the travel statuses of the user U1 (the travel statuses of the vehicle 50) as illustrated in a speech balloon B2 in FIG. 7 on the basis of activity history data recognized by the activity history information obtaining section 15 and stored in the activity history DB 34.

In next step S9, the proposed spot determining section 18 creates inference data 220 illustrated in FIG. 7 on the basis of the information about the candidate spot and the travel statuses of the user U1. The inference data 220 includes the class (“shopping use” here) to which the user U1 belongs, the information (proposal division and classification) about the candidate spot, and the travel statuses (the time slot, the drive time, the travel distance, and the number of stops in the day) of the user U1. In subsequent step S10, the proposed spot determining section 18 inputs the inference data 220 to the route proposing model 17 corresponding to the class of “shopping use” and obtains the output (propose/not propose) of a result of the inference as illustrated in a speech balloon B3 in FIG. 7.

It is to be noted that, in a case where the route proposing model 17 has not yet been generated for the user U1 because the collection of the proposal result data 200 (see FIG. 2) for the user U1 is insufficient, the proposed spot determining section 18 determines, as a proposed spot, a candidate spot in a genre that matches, for example, the preference of the user U1 recorded in the registered user data 201 (see FIG. 2).

In subsequent step S11, the proposed spot determining section 18 advances the process to step S12 when the output of the route proposing model 17 is “propose”. When the output of the route proposing model 17 is “not propose”, the proposed spot determining section 18 advances the process to step S18 in FIG. 6. In step S12, the proposed spot information output section 19 transmits proposed spot information that proposes to drop in at a proposed spot to the communication terminal 51 as illustrated with a speech balloon B4 in FIG. 7. The communication terminal 51 that receives the proposed spot information displays a drop-in proposing screen 55 on the display as illustrated in FIG. 7.

The drop-in proposing screen 55 displays the presence of a restaurant therearound which is a proposed spot, a Yes button 55a used to select the necessity to drop in, and a No button 55b used to select the unnecessity to drop in. The communication terminal 51 transmits, to the travel route proposing system 1, selection result information indicating a result of the selection by the user U1 operating the Yes button 55a or the No button 55b or making a voice input of Yes or No. In subsequent step S13 in FIG. 6, when receiving the selection result information transmitted from the communication terminal 51, the drop-in selection receiving section 20 advances the process to step S14.

In step S14, the drop-in selection receiving section 20 recognizes a result of the selection of the necessity or unnecessity to drop in at the proposed spot by the user U1 from the selection result information. The drop-in selection receiving section 20 then advances the process to step S15 when the result of the selection is the necessity to drop in. When the result of the selection is the unnecessity to drop in, the drop-in selection receiving section 20 advances the process to step S16. In the example of FIG. 7, as illustrated with a speech balloon B5, the user U1 selects the unnecessity to drop in and goes to the destination Pd (park) without dropping in at an Italian restaurant 70.

In step S15, the proposed route setting section 21 transmits information about a proposed route to the destination Pd through a proposed spot to the communication terminal 51. In a case where the restaurant 70 is a proposed spot in the example of FIG. 1, the proposed route setting section 21 transmits information about a proposed route R1 to the destination Pd through the restaurant 70 to the communication terminal 51. In addition, in a case where a restaurant 71 is a proposed spot, the proposed route setting section 21 transmits information about a proposed route R2 to the destination Pd through the restaurant 71 to the communication terminal 51.

It is to be noted that, in a case where the selection result information transmitted from the communication terminal 51 is not received in step S13 within a predetermined time from the time of the transmission of the information which proposes to drop in at a proposed spot to the communication terminal 51 in step S12, the drop-in selection receiving section 20 may determine that the user U1 selects the unnecessity to drop in at the proposed spot and advance the process to step S16 or advance the process to step S18.

In step S16, the activity history information obtaining section 15 generates proposal result data 200a for this time which includes a result of the selection of the necessity or unnecessity to drop in at a proposed spot as illustrated in a speech balloon B6 in FIG. 7. The activity history information obtaining section 15 adds the generated proposal result data 200a to the proposal result data 200 in the activity history DB 34 and records the added proposal result data 200a as illustrated in a speech balloon B7. In subsequent step S17, the route proposing model generating section 16 determines whether or not a predetermined number of pieces of proposal result data 200 or more are added to the activity history DB 34 for the class of “shopping use” that is a target class this time. The route proposing model generating section 16 then advances the process to step S30 when a predetermined number of pieces of proposal result data 200 or more are added. When a predetermined number of pieces of proposal result data 200 or more are not added, the route proposing model generating section 16 advances the process to step S18.

In step S20, the route proposing model generating section 16 carries out the machine learning (relearning) described above with reference to FIG. 4 on the route proposing model 17 including the added proposal result data 200 and corresponding to the class of “shopping use”, and updates the route proposing model 17 corresponding to the class of “shopping use”. In this way, the possibility that a proposed spot which matches the needs of users belonging to “shopping use” is determined is expected to be increased by reflecting the recent activity history of a user belonging to “shopping use” and updating the route proposing model 17 corresponding to the class of “shopping use”.

### 3. Other Embodiments

In the embodiment, the travel route proposing system according to the present disclosure is composed of the travel route proposing system 1 that is a computer system (server) which communicates with the communication terminal 51 used in the vehicle 50 and the communication terminal 60 carried by the user U2 through the communication network 100. As another embodiment, the travel route proposing system according to the present disclosure may be composed of the communication terminals 51 and 60. Alternatively, part of the travel route proposing system according to the present disclosure may be configured as a function of a server and the remainder may be composed of the communication terminals 51 and 60. In this case, the travel route proposing system according to the present disclosure is composed of the server and the communication terminal 51 or the communication terminal 60. For example, an aspect may be adopted in which the route proposing model generating section 16 and the proposed spot determining section 18 each having a heavy arithmetic processing load are included in the server and the other components are included in the communication terminals 51 and 60.

In the embodiment, the route proposing model generating section 16 generates the route proposing model 17 by using the training data 210 including information about a proposed spot, a travel status of the user U1, and a result of the selection of the necessity or unnecessity to drop in at the proposed spot by the user U1 as illustrated in FIG. 4. As another embodiment, training data that does not include a travel status of the user U1, but includes information about a proposed spot and a result of the selection of the necessity or unnecessity to drop in at the proposed spot by the user U1 may be used.

In the embodiment, the travel route proposing system 1 includes the desired arrival time recognizing section 13 and the proposed spot determining section 18 searches for a candidate spot under the condition that arrival at the destination Pd comes by desired arrival time. As another embodiment, the desired arrival time recognizing section 13 may be omitted and the proposed spot determining section 18 may be configured to search for a candidate spot without taking the desired arrival time into consideration.

In the embodiment, the route proposing model generating section 16 relearns the route proposing model 17 by using added proposal result data as illustrated in steps S17 and S30 in FIG. 6, but the route proposing model generating section 16 may be configured to refrain from relearning the route proposing model 17.

In the embodiment, the route proposing model generating section 16 is included and the proposed spot determining section 18 determines a proposed spot by using the route proposing model 17 generated by the route proposing model generating section 16. As another configuration, a proposed spot may be determined by another technique such as determining, as a proposed spot, a spot that matches the preference or the activity pattern of a user estimated from an activity history of the user without using the route proposing model 17 generated by machine learning.

It is to be noted that FIG. 1 is a schematic diagram in which the functional components of the travel route proposing system 1 are divided in accordance with the chief processing contents for facilitating the understanding of the invention of the present application. The functional components of the travel route proposing system 1 may be configured in accordance with other division. In addition, the process of each of the components may be executed by one hardware unit or executed by a plurality of hardware units. In addition, the processes of the respective components illustrated in FIGS. 5 and 6 may be each executed by one program or executed by a plurality of programs.

### 4. Configurations Supported by Embodiments Above

The embodiments described above are specific examples of the following configurations.

(Configuration 1) A travel route proposing system including: an activity history information obtaining section configured to obtain activity history information for a plurality of users, the activity history information indicating an activity history of each of the users; a user clustering section configured to classify a plurality of the users into a plurality of classes on the basis of the activity history information; a destination recognizing section configured to recognize a destination set by a target user who is any of a plurality of the users; a user position recognizing section configured to recognize a current position of the target user; a map information obtaining section configured to obtain map information about a target area including the destination and the current position of the target user; a proposed spot determining section configured to extract, on the basis of the map information, a candidate spot through which the target user is able to travel from the current position of the target user to the destination, and determine whether or not to use the candidate spot as a proposed spot to be proposed to the target user to drop in on the basis of the activity history information about the users belonging to a target class that is the class to which the target user belongs; and a proposed spot information output section configured to output information about the proposed spot.

The travel route proposing system according to Configuration 1 makes it possible to propose a stopover spot that is highly likely to match the needs of the target user on the basis of the activity history of the user in the target class to which the target user belongs when the target user sets the destination.

(Configuration 2) The travel route proposing system according to Configuration 1, including: a drop-in selection receiving section configured to receive selection of necessity or unnecessity to drop in at the proposed spot by the target user for an output of the information about the proposed spot by the proposed spot information output section; and a proposed route setting section configured to, when the selection of the necessity to drop in at the proposed spot is received by the drop-in selection receiving section, set a proposed route from the current position of the target user to the destination through the proposed spot on the basis of the map information.

The travel route proposing system according to Configuration 2 makes it possible to set the proposed route to the destination through the proposed spot depending on the selection of the necessity or unnecessity by the user.

(Configuration 3) The travel route proposing system according to Configuration 2, in which the activity history information includes proposal result data in which the information about the proposed spot and a result of reception of the selection of the necessity or unnecessity to drop in at the proposed spot by the drop-in selection receiving section are associated, the travel route proposing system includes a route proposing model generating section configured to generate a route proposing model for each of a plurality of the classes, the route proposing model carrying out machine learning for each of a plurality of the classes to output a determination as to whether or not to use the candidate spot as the proposed spot in response to an input of the information about the candidate spot, the machine learning using training data based on the proposal result data for each of the users belonging to the classes, and the proposed spot determining section determines whether or not to use the candidate spot as the proposed spot by using the route proposing model corresponding to the target class.

The travel route proposing system according to Configuration 3 makes it possible to reflect a result of the selection of the necessity or unnecessity to drop in at a proposed spot in the past by the user belonging to each of the classes for each of the plurality of classes, generate the route proposing model corresponding to each of the classes, and determine the proposed spot to the target user by using the route proposing model corresponding to the target class to which the target user belongs.

(Configuration 4) The travel route proposing system according to Configuration 3, in which the activity history information includes the proposal result data in which the information about the proposed spot and a travel status at time of a proposal, and the result of the reception of the selection of the necessity or unnecessity to drop in at the proposed spot by the drop-in selection receiving section are associated, the travel status being a travel status of the user at time when the proposed spot information output section outputs the information about the proposed spot, and the route proposing model generating section generates the route proposing model that outputs the determination as to whether or not to use the candidate spot as the proposed spot in response to inputs of the information about the candidate spot and the travel status of the user.

The travel route proposing system according to Configuration 4 makes it possible to generate the route proposing model in which the travel status of the user at the time of the output of the information about the proposed spot is reflected, and determine the proposed spot corresponding to the travel status of the target user by using the generated route proposing model.

(Configuration 5) The travel route proposing system according to Configuration 3 or 4, in which the route proposing model generating section assigns a weight to the candidate spot for which the selection of the necessity to drop in is received by the drop-in selection receiving section such that the candidate spot is extracted as the proposed spot more preferentially than the candidate spot for which the selection of the unnecessity to drop in is received by the drop-in selection receiving section, and generates the route proposing model by the machine learning.

The travel route proposing system according to Configuration 5 makes it possible to preferentially determine a candidate spot that approximates the proposed spot for which the selection of the necessity to drop in was made by the user in the past as a proposed spot to the target user this time.

(Configuration 6) The travel route proposing system according to any one of Configurations 3 to 5, in which, when new proposal result data is added to the activity history information, the route proposing model generating section uses the added proposal result data to relearn the route proposing model corresponding to the class to which the user targeted by the added proposal result data belongs.

The travel route proposing system according to Configuration 6 makes it possible to expect the possibility that a proposed spot which matches the needs of the target user is determined to be increased by reflecting the recent activity history of the user and updating the route proposing model.

(Configuration 7) The travel route proposing system according to any one of Configurations 1 to 6, including a desired arrival time recognizing section configured to recognize a desired arrival time that is an arrival time at the destination desired by the target user, in which the proposed spot determining section extracts, as the candidate spot, a spot that allows the target user to arrive at the destination by the desired arrival time after dropping in.

The travel route proposing system according to Configuration 7 makes it possible to extract the candidate spot depending on the schedule of the target user such that arrival at the destination comes by the desired arrival time.

(Configuration 8) A travel route proposing method that is executed by a computer, the travel route proposing method including: an activity history information obtaining step of obtaining activity history information for a plurality of users, the activity history information indicating an activity history of each of the users; a user clustering step of classifying a plurality of the users into a plurality of classes on the basis of the activity history information; a destination recognizing step of recognizing a destination set by a target user who is any of a plurality of the users; a user position recognizing step of recognizing a current position of the target user; a map information obtaining step of obtaining map information about a target area including the destination and the current position of the target user; a proposed spot determining step of extracting, on the basis of the map information, a candidate spot through which the target user is able to travel from the current position of the target user to the destination, and determining whether or not to use the candidate spot as a proposed spot to be proposed to the target user to drop in on the basis of the activity history information about the users belonging to a target class that is the class to which the target user belongs; and a proposed spot information output step of outputting information about the proposed spot.

The execution of the travel route proposing method according to Configuration 8 by the computer makes it possible to obtain the workings and effects similar to those of the travel route proposing system according to Configuration 1.

(Configuration 9) A non-transitory computer-readable storage medium storing a program that causes a computer to function as: an activity history information obtaining section configured to obtain activity history information for a plurality of users, the activity history information indicating an activity history of each of the users; a user clustering section configured to classify a plurality of the users into a plurality of classes on the basis of the activity history information; a destination recognizing section configured to recognize a destination set by a target user who is any of a plurality of the users; a user position recognizing section configured to recognize a current position of the target user; a map information obtaining section configured to obtain map information about a target area including the destination and the current position of the target user; a proposed spot determining section configured to extract, on the basis of the map information, a candidate spot through which the target user is able to travel from the current position of the target user to the destination, and determine whether or not to use the candidate spot as a proposed spot to be proposed to the target user to drop in on the basis of the activity history information about the users belonging to a target class that is the class to which the target user belongs; and a proposed spot information output section configured to output information about the proposed spot.

The execution of the program according to Configuration 9 by the computer makes it possible to achieve the components of the travel route proposing system according to Configuration 1.

### REFERENCE SIGNS LIST

1 travel route proposing system
10 processor
11 user position recognizing section
12 destination recognizing section
13 desired arrival time recognizing section
14 map information obtaining section
15 activity history information obtaining section
16 route proposing model generating section
17 route proposing model
18 proposed spot determining section
19 proposed spot information output section
20 drop-in selection receiving section
21 proposed route setting section
22 user clustering section
30 storage device
31 program for controlling travel route proposing system
32 machine learning platform program
33 user DB
34 activity history DB
40 communication unit
50 vehicle
51 communication terminal
60 communication terminal
70, 71 restaurant
100 communication network
110 traffic information server
120 spot information server
130 vehicle support server
200 proposal result data
201 registered user data
202 visit record data
U1, U2 user
Ps current position (of user)
Pd destination

1. A travel route proposing system comprising:
an activity history information obtaining section configured to obtain activity history information for a plurality of users, the activity history information indicating an activity history of each of the users;
a user clustering section configured to classify a plurality of the users into a plurality of classes on a basis of the activity history information;
a destination recognizing section configured to recognize a destination set by a target user who is any of a plurality of the users;
a user position recognizing section configured to recognize a current position of the target user;
a map information obtaining section configured to obtain map information about a target area including the destination and the current position of the target user;
a proposed spot determining section configured to extract, on a basis of the map information, a candidate spot through which the target user is able to travel from the current position of the target user to the destination, and determine whether or not to use the candidate spot as a proposed spot to be proposed to the target user to drop in on the basis of the activity history information about the users belonging to a target class that is the class to which the target user belongs; and
a proposed spot information output section configured to output information about the proposed spot.

2. The travel route proposing system according to claim 1, comprising:
a drop-in selection receiving section configured to receive selection of necessity or unnecessity to drop in at the proposed spot by the target user for an output of the information about the proposed spot by the proposed spot information output section; and
a proposed route setting section configured to, when the selection of the necessity to drop in at the proposed spot is received by the drop-in selection receiving section, set a proposed route from the current position of the target user to the destination through the proposed spot on the basis of the map information.

3. The travel route proposing system according to claim 2, wherein
the activity history information includes proposal result data in which the information about the proposed spot and a result of reception of the selection of the necessity or unnecessity to drop in at the proposed spot by the drop-in selection receiving section are associated,
the travel route proposing system comprises a route proposing model generating section configured to generate a route proposing model for each of a plurality of the classes, the route proposing model carrying out machine learning for each of a plurality of the classes to output a determination as to whether or not to use the candidate spot as the proposed spot in response to an input of the information about the candidate spot, the machine learning using training data based on the proposal result data for each of the users belonging to the classes, and
the proposed spot determining section determines whether or not to use the candidate spot as the proposed spot by using the route proposing model corresponding to the target class.

4. The travel route proposing system according to claim 3, wherein
the activity history information includes the proposal result data in which the information about the proposed spot and a travel status at time of a proposal, and the result of the reception of the selection of the necessity or unnecessity to drop in at the proposed spot by the drop-in selection receiving section are associated, the travel status being a travel status of the user at time when the proposed spot information output section outputs the information about the proposed spot, and
the route proposing model generating section generates the route proposing model that outputs the determination as to whether or not to use the candidate spot as the proposed spot in response to inputs of the information about the candidate spot and the travel status of the user.

5. The travel route proposing system according to claim 3, wherein the route proposing model generating section assigns a weight to the candidate spot for which the selection of the necessity to drop in is received by the drop-in selection receiving section such that the candidate spot is extracted as the proposed spot more preferentially than the candidate spot for which the selection of the unnecessity to drop in is received by the drop-in selection receiving section, and generates the route proposing model by the machine learning.

6. The travel route proposing system according to claim 3, wherein, when new proposal result data is added to the activity history information, the route proposing model generating section uses the added proposal result data to relearn the route proposing model corresponding to the class to which the user targeted by the added proposal result data belongs.

7. The travel route proposing system according to claim 1, comprising a desired arrival time recognizing section configured to recognize a desired arrival time that is an arrival time at the destination desired by the target user, wherein
the proposed spot determining section extracts, as the candidate spot, a spot that allows the target user to arrive at the destination by the desired arrival time after dropping in.

8. A travel route proposing method that is executed by a computer, the travel route proposing method comprising:
an activity history information obtaining step of obtaining activity history information for a plurality of users, the activity history information indicating an activity history of each of the users;
a user clustering step of classifying a plurality of the users into a plurality of classes on a basis of the activity history information;
a destination recognizing step of recognizing a destination set by a target user who is any of a plurality of the users;
a user position recognizing step of recognizing a current position of the target user;
a map information obtaining step of obtaining map information about a target area including the destination and the current position of the target user;
a proposed spot determining step of extracting, on a basis of the map information, a candidate spot through which the target user is able to travel from the current position of the target user to the destination, and determining whether or not to use the candidate spot as a proposed spot to be proposed to the target user to drop in on the basis of the activity history information about the users belonging to a target class that is the class to which the target user belongs; and
a proposed spot information output step of outputting information about the proposed spot.

9. A non-transitory computer-readable storage medium storing a program that causes a computer to function as:
an activity history information obtaining section configured to obtain activity history information for a plurality of users, the activity history information indicating an activity history of each of the users;
a user clustering section configured to classify a plurality of the users into a plurality of classes on a basis of the activity history information;
a destination recognizing section configured to recognize a destination set by a target user who is any of a plurality of the users;
a user position recognizing section configured to recognize a current position of the target user;
a map information obtaining section configured to obtain map information about a target area including the destination and the current position of the target user;
a proposed spot determining section configured to extract, on a basis of the map information, a candidate spot through which the target user is able to travel from the current position of the target user to the destination, and determine whether or not to use the candidate spot as a proposed spot to be proposed to the target user to drop in on the basis of the activity history information about the users belonging to a target class that is the class to which the target user belongs; and
a proposed spot information output section configured to output information about the proposed spot.
